(19) United States
(12) Patent Application Publication
(10) Pub. No.: US 2015/0339023 A1
(43) Pub. Date: Nov. 26, 2015

(54) DISPLAY DEVICE WITH WINDOW

(71) Applicant: SAMSUNG DISPLAY CO., LTD., Yongin-si (KR)

(72) Inventors: Seo-Yeon PARK, Seoul (KR); Hye-Rin HWANG, Icheon-si (KR)

(21) Appl. No.: 14/490,308

(22) Filed: Sep. 18, 2014

(30) Foreign Application Priority Data
May 20, 2014 (KR) 10-2014-0060269

(51) Int. Cl. G06F 3/0488; G06F 3/00

(52) U.S. Cl. CPC G06F 3/0488; G06F 3/005

(57) ABSTRACT

A display device with a window includes a display panel configured to detect touch and to display an image, a back-facing photographing part configured to photograph a background that includes a space behind the display panel, and a panel driver configured to display a background image photographed by the back-facing photographing part on the display panel and to magnify or demagnify the background image by a touch gesture performed on the display panel so as to display the magnified or demagnified image on the display panel.

### CROSS-REFERENCE TO RELATED APPLICATION

This application claims priority to and the benefit of Korean Patent Application No. 10-2014-0060269, filed on May 20, 2014, with the Korean Intellectual Property Office, the disclosure of which application is incorporated herein in its entirety by reference.

### BACKGROUND

1. Field

Embodiments of the present system and method relate to a display device that serves as a window and is capable of being mounted to a building, which has a telescopic function that magnifies or demagnifies a view from the window for observation.

2. Description of Related Technology

Various types of display devices are being used with the development of electronic technology, including transparent display devices that display letters or images while retaining visual transparency. Transparent display devices may be manufactured using a transparent electronic device made of a transparent material on a transparent substrate such as glass. Transparent display devices may be utilized in many different environments for various purposes. For example, transparent display devices may be used on the windows of homes or shops, or the windshields of cars or other vehicles so as to provide users with desired information or advertisements or promotions.

Telescopes, which aid in the observation of distant, surrounding views, may be housed in an observatory building of a tourist attraction. Visitors may be required to look for where the telescopes are housed and the number of telescopes is often insufficient compared to the number of visitors, such that it may take the visitors a lot of time to use telescopes of an observatory building. Further, while a telescope may aid in the observation of a remote region, it generally does not furnish visitors with information on the region (e.g., a geographical location of the region).

### SUMMARY

Aspects of embodiments of the present system and method are directed to a display device with a window that is capable of performing a telescopic function and being mounted in a building structure. The display device is also capable of furnishing information, e.g., geographical information about objects or regions being viewed from the display device.

According to an embodiment, a display device with a window includes: a display panel configured to detect touch and to display an image; a back-facing photographing part configured to photograph a background that includes a space behind the display panel; and a panel driver configured to display a background image photographed by the back-facing photographing part on the display panel and to magnify or demagnify the background image by a touch gesture performed on the display panel so as to display the magnified or demagnified image on the display panel.

The display device with a window may further include: a user sensor configured to sense whether or not a user is present in a predetermined sensing region; a front-facing photographing part configured to photograph a foreground that includes a space in front of the display panel; and a location determining unit configured to calculate a display location for an information window from a foreground image photographed by the front-facing photographing part.

When the user sensor detects a user's presence in the predetermined sensing region, the front-facing photographing part may photograph the foreground including the user.

When the user sensor detects a user's presence in the predetermined sensing region, the panel driver may display an information symbol and a scale bar on the display panel.

When the information symbol is touched, the panel driver may display the information window on the display panel in accordance with the display location for the information window.

When the user sensor detects a user's absence in the predetermined sensing region, the panel driver may remove at least one of the background image displayed on the display panel, the foreground image, the information symbol, the scale bar, and the information window.

The panel driver may display the information window on the display panel such that the information window may correspond to an eye level of the user.

The information window may include: a first symbol configured to provide previous images of the background that are categorized by time period; a second symbol configured to provide a map showing regions included in the background; a third symbol configured to provide a search function for facilities or tourist attractions included in the background and also provide location information of the facilities or tourist attractions; and a fourth symbol configured to activate the back-facing photographing part to capture an image of the background and transmit the captured image of the background to a remote device.

The first symbol may further offer at least one sub-symbol configured to give at least one style effect to the background image.

When a specific region included in the background image is touched, the panel driver may display a sign that indicates the specific region on the display panel for a predetermined period of time.

The panel driver may display a regional information window that includes regional information associated with the specific region on the display panel and also display a sign that indicates the specific region on the display panel.

The regional information window may be displayed on the display panel to correspond to an eye level of a user.

According to embodiments of the present system and method, a display device with a window is capable of serving as a window of a building, performing a telescopic function, and furnishing geographical information about regions viewed from the window according to user selections, thereby enhancing users' convenience.

Further, according to embodiments of the present system and method, a display device with a window is capable of styling and providing previous time-based images of a background viewed from a window, thereby satisfying emotional needs of users.

The description herein is illustrative only and is not intended to be limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present system and method will be more clearly understood from the following detailed description taken in conjunction with the accompanying drawings, in which:

FIG. 1 is a perspective view of a display device with a window according to an embodiment of the present system and method;

FIG. 2 is a partially enlarged view of part “A” of FIG. 1;

FIG. 3 is a cross-sectional view taken along line I-I′ of FIG. 2;

FIGS. 4A to 4C are diagrams that illustrate a telescopic function of a display device with a window according to an embodiment of the present system and method;

FIGS. 5A and 5B illustrate displaying an information window in a display device with a window according to an embodiment of the present system and method;

FIG. 6 is a diagram that illustrates a configuration of the information window shown in FIG. 5B; and

FIGS. 7A and 7B are diagrams that illustrate an operation of a display device with a window according to one embodiment, which results from a touch gesture indicating a specific region.

### DETAILED DESCRIPTION

Hereinafter, embodiments of the present system and method are described with reference to the accompanying drawings.

Example embodiments of the present system and method are illustrated in the accompanying drawings and described in the specification. The scope of the present system and method is not limited to the example embodiments and would be understood by those of ordinary skill in the art to include various changes, equivalents, and substitutions to the example embodiments.

In the specification, when a first element is referred to as being “connected” to a second element, the first element may be directly connected to the second element or indirectly connected to the second element with one or more intervening elements interposed therebetween. The terms “comprises,” “comprising,” “includes,” and/or “including,” when used in this specification, may specify the presence of stated features, integers, steps, operations, elements, and/or components, but do not preclude the presence or addition of one or more other features, integers, steps, operations, elements, and/or components.

Although the terms “first,” “second,” and “third” and the like may be used herein to describe various elements, the elements should not be limited by these terms. That is, while these terms may be used to distinguish one element from another element, they do not limit the elements themselves. Thus, any element may be referred to as “a first element,” “a second element,” or “a third element.” The description of an element as a “first” element does not require or imply the presence of a second element or other elements. The terms “first,” “second,” etc. may also be used herein to differentiate different categories or sets of elements. In such context, the terms “first,” “second,” etc. may represent “first-type (or first-set),” “second-type (or second-set),” etc., respectively.

Like reference numerals may refer to like elements in the specification.

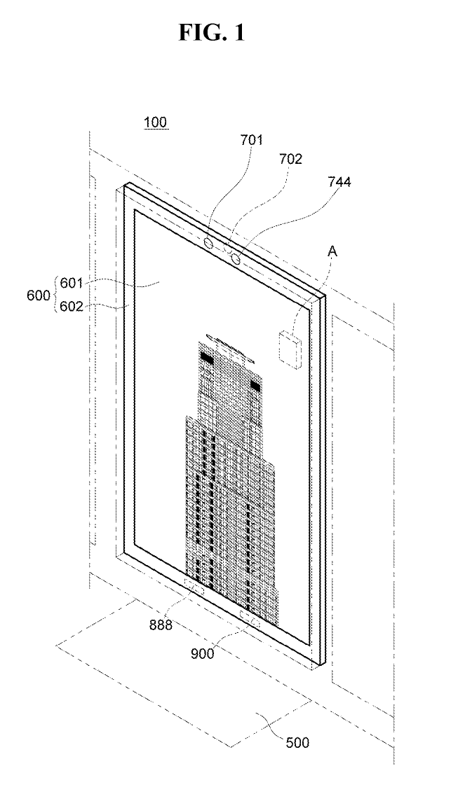

FIG. 1 is a perspective view of a display device with a window according to an embodiment of the present system and method. A “window,” as used herein, includes an apparatus or a region of an apparatus that allows incident light to pass through. Referring to FIG. 1, the display device 100 with a window includes a display panel 600, a front-facing photographing part 701, a back-facing photographing part 702, a user sensor 744, a location determining unit 900, and a panel driver 888, each of which is described below.

The display panel 600 may display an image and detect touches that are externally produced. The display panel 600 may allow transmission of externally incident light, and to this end, components of the display panel 600 may be made of transparent materials. The display panel 600 may be divided into two areas: a display area 601 and a non-display area 602.

The display area 601 may include a central portion of the display panel 600 and may include a plurality of pixels so as to display an image. The plurality of pixels may be classified into three categories: a plurality of red pixels that displays a red color; a plurality of green pixels that displays a green color; and a plurality of blue pixels that displays a blue color. The pixels of three different colors adjacent to each other may form a unit pixel that displays one unit image. The display area 601 may further include at least one touch sensor configured to detect touch that is externally produced. The touch sensor may be disposed in a pixel or may be independently disposed on a separate touch panel.

The non-display area 602 may include an edge portion of the display panel 600. The non-display area 602 may be covered with an external case (not shown) that is made of opaque materials.

The front-facing photographing part 701, the back-facing photographing part 702, the user sensor 744, the location determining unit 900, the panel driver 888, and other lines (not shown) for electrical connections between the above-listed components and operations thereof may be disposed on a separate printed circuit board (not shown) so as to be accommodated in the external case.

Furthermore, the front-facing photographing part 701, the back-facing photographing part 702, the user sensor 744, the location determining unit 900, the panel driver 888, and other lines may be disposed in the non-display area 602 of the display panel 600 to reduce a bezel width of the display device 100 of a window, as illustrated in FIG. 1.

The front-facing photographing part 701, the back-facing photographing part 702, and the user sensor 744 may be exposed outwards through one or more openings in the external case. For instance, the front-facing photographing part 701 and the back-facing photographing part 702 may include a camera and the user sensor 744 may include a thermal sensor, a motion sensor, and the like, and the external case may have openings that expose the cameras and lenses of the sensor. In one embodiment, the front-facing photographing part 701 and the user sensor 744 may be mounted on a front side of the display panel 600, whereas the back-facing photographing part 702 may be mounted on a back side (i.e., the side facing away from the front side) of the display panel 600. The front-facing photographing part 701 and the user sensor 744 may be disposed in the non-display area 602 that corresponds to an upper edge portion of the front side of the display panel 600. The back-facing photographing part 702 may be disposed in the non-display area 602 that corresponds to an upper edge portion of the back side of the display panel 600

The user sensor 744 may monitor a detection area 500 periodically so as to determine whether or not a user is present therein. If the user sensor 744 detects a user's presence in the detection area 500, the user sensor 744 may generate a detection signal as a result of the detection. In one embodiment, the detection area 500 may be placed in front of the display panel 600, but the present system and method are not limited thereto. A space in front of the display panel 600 may be adjacent to (or may adjoin) the front of the display panel 600. For example, the space may refer to an interior space of a building when the display device 100 is used as a window of the building.

The user sensor 744 may include either a thermal detector or a motion detector. In some cases, the user sensor 744 may include both the thermal detector and the motion detector to increase detection accuracy in detecting the presence of a human body. the user sensor may be a human body detecting sensor that performs functions of the thermal detector and the motion detector all together. The front-facing photographing part 701 may photograph a foreground of the display panel 600 when the user sensor 744 detects the presence of a user in the detection area 500. The foreground of the display panel 600 may refer to a view of the space in front of the display panel 600 with respect to the display panel 600. In other words, a detection signal may be input from the user sensor 744 to the front-facing photographing part 701 and the front-facing photographing part 701 may photograph the foreground in response to the input detection signal. Thus, the user present in the detection area 500 may be photographed together with the foreground. In some cases, even when the user is not detected within the detection area 500, the front-facing photographing part 701 may photograph the user and the foreground together.

An image photographed by the front-facing photographing part 701 (hereinafter referred to as a “foreground image”) may include at least one of the images of the user and the foreground. The foreground image may be converted to data (hereinafter referred to as “foreground image data”) so as to be transmitted to the location determining unit 900.

The location determining unit 900 may analyze the foreground image data transmitted from the front-facing photographing part 701 and may extract information about at least one of the user's height and a location of the user's eyes in the image. A display location for displaying an information window in the display area 601 may be determined based on the extracted information (e.g., at least one of the user's height and eye location). The display location may refer to a planar coordinate in the display area 601 at which the information window may be displayed and may be stored in a memory (not shown). The display location stored in the memory may remain unchanged until a new display location is input.

The back-facing photographing part 702 may photograph a background (e.g., a space outside a window) of the display panel 600. The background of the display panel 600 may denote a view of a space behind the display panel 600 with respect to the display panel 600. The space behind the display panel 600 may be adjacent to (or may adjoin) the rear of the display panel 600. For example, the space may refer to an exterior space of a building when the display device 100 is used as a window of the building. The back-facing photographing part 702 may be controlled by the panel driver 888, which is described below.

The panel driver 888 may drive the display panel 600 to display an image on the display panel 600. In one embodiment, the panel driver 888 may process external image data supplied from an external system (not shown) in accordance with a preset time and may supply the processed external image data to the display panel 600. The panel driver 888 may also supply preset detection image data to the display panel 600 in response to the detection signal provided from the user sensor 744. When the display panel 600 is touched, the panel driver 888 may calculate a touch coordinate, may process prepared touch image data based on a preset time according to the calculated touch coordinate, and may supply the processed touch image data to the display panel 600. The external image data, the detection image data, and the touch image data, which are supplied to the display panel 600, may be displayed as images in the display area 601 of the display panel 600.

When the user sensor 744 determines that a user is not present in the detection area 500, the panel driver 888 may drive the display panel 600 so as to remove an image displayed in the display area 601. In such a case, the display device 100 according to one embodiment may act as a transparent window. The removed image may be at least one of a background image, a foreground image including the detection area 500, an information symbol, a scale bar, and an information window.

The location determining unit 900 may be built in the panel driver 888. In one embodiment, functions of the location determining unit 900 may be added to the panel driver 888 so that the panel driver 888 may further implement the functions. The panel driver 888 may include a chip in which electronic components are integrated to enable the panel driver 888 to implement all of the above functions.

A touch panel may include one of an organic light emitting diode (OLED), a liquid crystal display (LCD), and an electrophoretic display (EPD). Such display devices may be driven by a thin film transistor (TFT). Hereinafter, an OLED display device is used in the description of an embodiment.

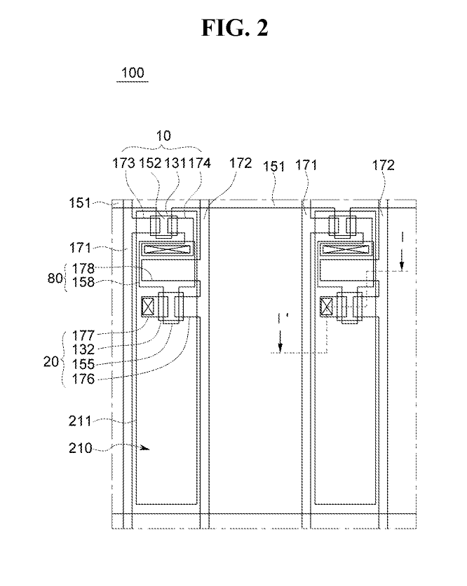

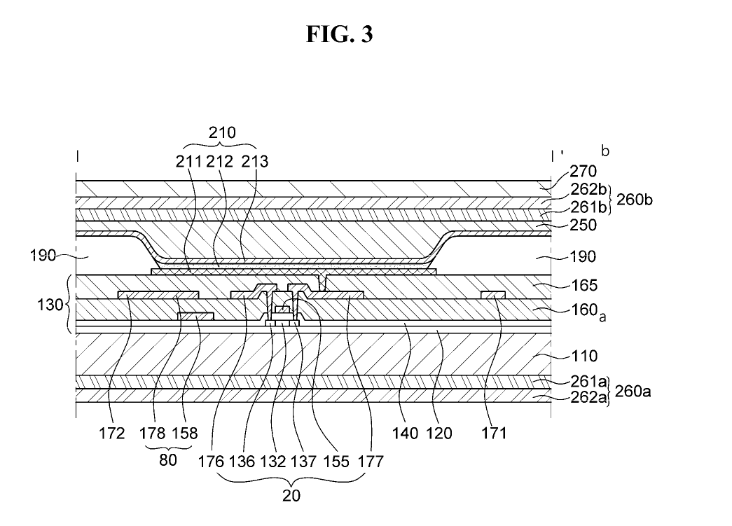

FIG. 2 is a partially enlarged view of part “A” of FIG. 1. FIG. 3 is a cross-sectional view taken along line I-I′ of FIG. 2.

Referring to FIGS. 2 and 3, the display panel 600 included in the display device 100 according to one embodiment may include a substrate 110, a driving circuit unit 130 on the substrate 110, a display element unit 210 on the driving circuit unit 130, a sealing member 250 on the display element unit 210, and a touch panel 270 on the sealing member 250.

The display device 100 may further include a first coating layer 260a, which may be disposed on a rear surface of the substrate 110. The display device 100 may further include a second coating layer 260b, which may be disposed between the sealing member 250 and the touch panel 270. The first coating layer 260a may include at least one of a water-proof coating layer 261a and a heat-proof coating layer 262a. Also, the second coating layer 260b may include at least one of a water-proof coating layer 261b and a heat-proof coating layer 262b. The driving circuit unit 130 that is configured to drive the display element unit 210 may be disposed on the substrate 110. The driving circuit unit 130 may include a switching TFT 10, a driving TFT 20, and a capacitor 80, and may drive an OLED of the display element unit 210. The touch panel 270 may include touch sensors to detect touches that are externally produced.

Although the detailed structures of the driving circuit unit 130 and the display element unit 210 are illustrated in FIGS. 2 and 3, embodiments of the present system and method are not limited to FIGS. 2 and 3. Those of ordinary skill in the art would understand that the driving circuit unit 130 and the display element unit 210 may be embodied in many different forms.

FIG. 2 illustrates an embodiment in which one pixel includes two TFTs and a capacitor, but embodiments of the present system and method are not limited thereto. For example, one pixel may include three or more TFTs and two or more capacitors, and may further include conductive lines. The display device 100 according to one embodiment may have other different structures. Herein, the term “pixel” refers to the smallest unit for displaying an image, and the pixel may be any one of a red pixel, a green pixel, and a blue pixel.

Referring to FIGS. 2 and 3, every pixel may include the switching TFT 10, the driving TFT 20, the capacitor 80, and the display element unit 210. The configuration including the switching TFT 10, the driving TFT 20, and the capacitor 80 is herein referred to as the driving circuit unit 130.

The driving circuit unit 130 may further include a gate line 151 that extends along one direction, a data line 171 that is insulated from and intersects (crosses) the gate line 151, and a common power supply line 172. In one embodiment, a pixel may be defined by the gate line 151, the data line 171, and the common power supply line 172, but may be defined differently in other embodiments. For example, in another embodiment, a pixel may be defined by a black matrix or a pixel defining layer (PDL).

The substrate 110 may be a transparent insulating substrate, such as one made of glass, transparent plastic, or the like. In one embodiment, the substrate 110 may be made of a material selected from Kapton®, polyethersulphone (PES), polycarbonate (PC), polyimide (PI), polyethyleneterephthalate (PET), polyethylenenaphthalate (PEN), polyacrylate (PAR), and fiber reinforced plastic (FRP).

A buffer layer 120 may be disposed on the substrate 110. The buffer layer 120 may prevent infiltration of undesirable elements such as impurities and moisture, and may provide a planar surface. The buffer layer 120 may be made of a suitable material for planarizing and/or preventing infiltration. For example, the buffer layer 120 may include at least one selected from silicon nitride (SiNₓ), silicon oxide (SiO₂), and silicon oxynitride (SiOₓN_{y}). In some embodiments, the buffer layer 120 may be omitted depending on the material type and process conditions of the substrate 110.

A switching semiconductor layer 131 and a driving semiconductor layer 132 may be disposed on the buffer layer 120. The switching and driving semiconductor layers 131 and 132 may include at least one of polycrystalline silicon, amorphous silicon, and oxide semiconductors such as indium gallium zinc oxide (IGZO) and indium zinc tin oxide (IZTO). For instance, when the driving semiconductor layer 132 illustrated in FIG. 3 is made of the polycrystalline silicon, the driving semiconductor layer 132 may include a channel area that is not doped with impurities and p+ doped source and drain areas positioned on opposite ends of the channel area. P-type impurities such as boron B may be used as dopant ions. For example, B₂H₆ may be used. Such impurities may vary depending on the types of thin-film transistors (TFTs) to be formed. According to one embodiment, a PMOS (P-channel Metal Oxide Semiconductor)-structured TFT using the p-type impurities is used as the driving TFT 20, but embodiments of the present system and method are not limited thereto. For example, an NMOS (N-channel Metal Oxide Semiconductor)-structured or CMOS (Complementary Metal Oxide Semiconductor)-structured TFT may also be used as the driving TFT 20.

A gate insulating layer 140 may be disposed on the switching and driving semiconductor layers 131 and 132. The gate insulating layer 140 may include at least one selected from tetraethyl orthosilicate (TEOS), silicon nitride (SiNₓ), and silicon oxide (SiO₂). For instance, the gate insulating layer 140 may have a double layer structure in which a silicon nitride layer having a thickness of about 40 nm and a TEOS layer having a thickness of about 80 nm are sequentially laminated, but embodiments of the present system and method are not limited thereto.

A gate wire that includes gate electrodes 152 and 155 may be disposed on the gate insulating layer 140. The gate wire may further include a gate line 151, a first capacitor plate 158, and other lines. The gate electrodes 152 and 155 may be disposed to overlap a part or all of the semiconductor layers 131 and 132, e.g., to overlap the channel area. The gate electrodes 152 and 155 may prevent the channel area from being doped with impurities when the source and drain areas 136 and 137 of the semiconductor layers 131 and 132 are doped with the impurities in the process of forming the semiconductor layers 131 and 132.

The gate electrodes 152 and 155 and the first capacitor plate 158 may be disposed on the same layer and may be made of substantially the same metal material. The gate electrodes 152 and 155 and the first capacitor plate 158 may include at least one selected from molybdenum (Mo), chromium (Cr), and tungsten (W).

An interlayer insulating layer 160 configured to cover the gate electrodes 152 and 155 may be disposed on the gate insulating layer 140. The interlayer insulating layer 160 may be made of tetraethyl orthosilicate (TEOS), silicon nitride (SiNₓ), or silicon oxide (SiOₓ) similar to the gate insulating layer 140, but embodiments of the present system and method are not limited thereto.

A data wire including source electrodes 173 and 176 and drain electrodes 174 and 177 may be disposed on the interlayer insulating layer 160. The data wire may further include a data line 171, a common power supply line 172, a second capacitor plate 178, and other lines. The source electrodes 173 and 176 and the drain electrodes 174 and 177 may be respectively coupled to the source area 136 and the drain area 137 of the semiconductor layers 131 and 132 through a contact opening formed in the gate insulating layer 140 and the interlayer insulating layer 160.

Thus, the switching TFT 10 may include the switching semiconductor layer 131, the switching gate electrode 152, the switching source electrode 173, and the switching drain electrode 174, and the driving TFT 20 may include the driving semiconductor layer 132, the driving gate electrode 155, the driving source electrode 176, and the driving drain electrode 177. The configurations of the TFTs 10 and 20 are not limited to the above-described embodiment and may vary according to other configurations understood by those of ordinary skill in the art.

The capacitor 80 may include the first capacitor plate 158 and the second capacitor plate 178 with the interlayer insulating layer 160 interposed therebetween.

The switching TFT 10 may function as a switching device that selects a pixel to perform light emission. The switching gate electrode 152 may be coupled to the gate line 151. The switching source electrode 173 may be coupled to the data line 171. The switching drain electrode 174 may be spaced apart from the switching source electrode 173 and coupled to the first capacitor plate 158.

The driving TFT 20 may apply a driving power to a pixel electrode 211 to enable a light emitting layer 212 of the display element unit 210 in a selected pixel to emit light. The driving gate electrode 155 may be coupled to the first capacitor plate 158. The driving source electrode 176 and the second capacitor plate 178 may be coupled to the common power supply line 172. The driving drain electrode 177 may be coupled to the pixel electrode 211 of the display element unit 210 through a contact hole.

The switching TFT 10 may be operated by a gate voltage applied to the gate line 151, and may function to transmit a data voltage applied to the data line 171 to the driving TFT 20. A voltage equivalent to a differential between a common voltage applied to the driving TFT 20 from the common power supply line 172 and the data voltage transmitted from the switching TFT 10 may be stored in the capacitor 80, and a current that corresponds to the voltage stored in the capacitor 80 may flow to the display element unit 210 through the driving TFT 20 so that the display element unit 210 may emit light.

A planarization layer 165 may be disposed on the interlayer insulating layer 160 and may be configured to cover the data wire patterned on the same layer as the data line 171, the common power supply line 172, the source electrodes 173 and 176, the drain electrodes 174 and 177, the second capacitor plate 178, and the like.

The planarization layer 165 may serve to planarize a surface of the display element unit 210 that is disposed on the planarization layer 165 by eliminating or reducing steps so as to increase light emission efficiency of the display element unit 210. The planarization layer 165 may be made of at least one selected from a polyacrylate resin, an epoxy resin, a phenolic resin, a polyamide resin, a polyimide resin, an unsaturated polyester resin, a polyphenylenether resin, a polyphenylene sulfide resin, and benzocyclobutene (BCB).

The pixel electrode 211 of the display element unit 210 may be disposed on the planarization layer 165. The pixel electrode 211 may be coupled to the drain electrode 177 through a contact opening of the planarization layer 165.

A part or all of the pixel electrode 211 may be disposed in a pixel area. That is, the pixel electrode 211 may be disposed to correspond to the pixel area defined by a pixel defining layer (PDL) 190. The PDL 190 may be made of a polyacrylate resin or a polyimide resin.

The light emitting layer 212 may be disposed on the pixel electrode 211 in the pixel area and a common electrode 213 may be disposed on the PDL 190 and the light emitting layer 212. The light emitting layer 212 may include a low molecular weight organic material or a high molecular weight organic material. At least one of a hole injection layer (HIL) and a hole transport layer (HTL) may be disposed between the pixel electrode 211 and the light emitting layer 212, and at least one of an electron transport layer (ETL) and an electron injection layer (EIL) may be disposed between the light emitting layer 212 and the common electrode 213.

The pixel electrode 211 and the common electrode 213 may be any one of a transmissive electrode, a transflective electrode, and a reflective electrode. A transparent conductive oxide (TCO) may be used to form the transmissive electrode. The TCO may include at least one selected from indium tin oxide (ITO), indium zinc oxide (IZO), antimony tin oxide (ATO), aluminum zinc oxide (AZO), zinc oxide (ZnO), and mixtures thereof.

A metal such as magnesium (Mg), silver (Ag), gold (Au), calcium (Ca), Lithium (Li), Chromium (Cr), aluminum (Al), and copper (Cu), or alloys thereof may be used to form the transflective electrode and the reflective electrode. In this case, the transflective electrode and the reflective electrode may have different thicknesses. For example, the transflective electrode may have a thickness of about 200 nm or less and the reflective electrode may have a thickness of about 300 nm or greater. As the thickness of the transflective electrode decreases, both light transmittance and resistance may increase. Conversely, as the thickness of the transflective electrode increases, light transmittance may decrease. The transflective electrode and the reflective electrode may have a multilayer structure that includes a metal layer made of a metal or an alloy thereof and a transparent conductive oxide layer laminated on the metal layer.

According to one embodiment, the display device 100 with a window may have a dual-side emission structure. That is, light may be emitted in both directions of the pixel electrode 211 and the common electrode 213. In such a case, the pixel electrode 211 and the common electrode 213 may be made of a transmissive or transflective electrode.

The sealing members 250 may be disposed on the common electrode 213. The sealing member 250 may be a transparent insulating substrate such as one made of glass or transparent plastic. The sealing member 250 may have a thin-film encapsulation structure in which one or more inorganic layers and one or more organic layers are alternately laminated.

Water-proof coating layers 261a and 261b may be made of a polymer material that has transparency. The water-proof coating layers 261a and 261b may be made of, for example, polyester or parylene. The water-proof coating layers 261a and 261b may be coated by deposition of thermal diffusion at room temperature or may be formed by being bonded in a film form. In addition, water-proof coating materials generally used in the art may also be applied to embodiments of the present system and method.

The heat-proof coating layers 262a and 262b may be made of a material that has transparency and high thermal conductivity. For example, the heat-proof coating layers 262a and 262b may be made of a graphite sheet or acrylic sheet. In addition, heat-proof coating materials generally used in the art may also be applied to embodiments of the present system and method.

When the display panel 600 has the pixel structure illustrated in FIGS. 2 and 3, the panel driver 888 may include a gate driver (not shown) configured to apply a gate voltage to the gate lines 151, a data driver (not shown) configured to apply a data voltage (external image data, detection image data, touch image data, etc.) to the data lines 171, a power supply unit (not shown) configured to apply a drive voltage to the common power supply line 172, and a timing controller (not shown). The timing controller may control operations of the gate driver, the data driver, the power supply unit, the front-facing photographing part 701, the back-facing photographing part 702, the user sensor 744, and the location determining unit 900 and may process the image data (external image data, detection image data, touch image data, etc.).

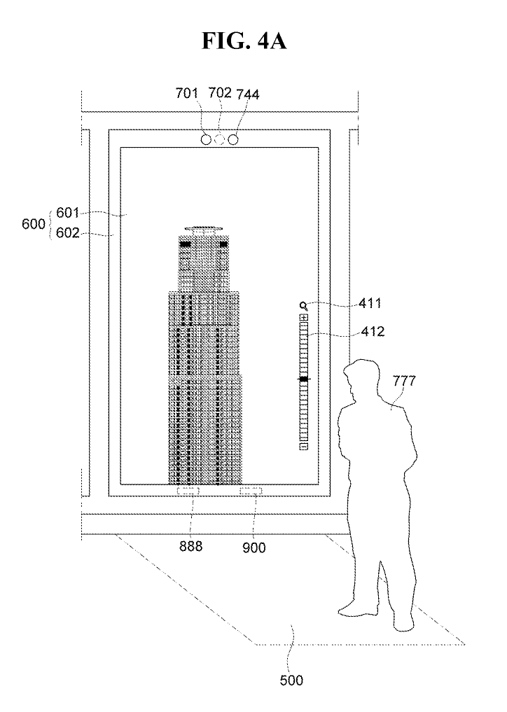

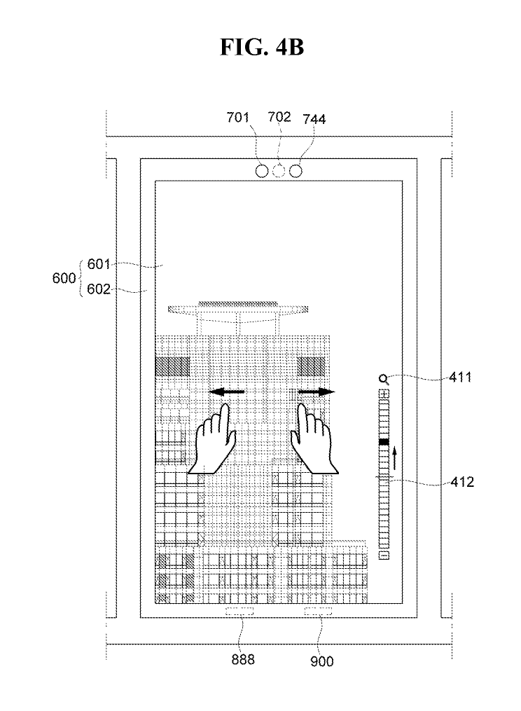

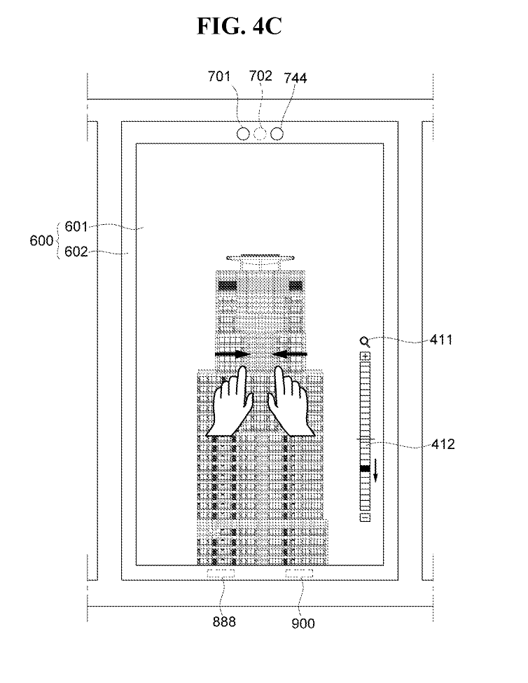

According to one embodiment, an operation of the display device 100 with a window configured as above is described below. FIGS. 4A to 4C are diagrams that illustrate a telescopic function of a display device 100 with a window according to an embodiment of the present system and method.

As illustrated in FIG. 4A, when a user 777 enters the detection area 500, the user sensor 744 may detect the user's presence and generate a detection signal as a result of the detection. The detection signal may be input to the front-facing photographing part 701 and the panel driver 888.

The front-facing photographing part 701 may photograph the user 777 in the detection area 500 in response to the detection signal. A photographed image of the user 777 may be transmitted to the location determining unit 900, the location determining unit 900 may calculate a plane coordinate for displaying the information window in the display area 601 based on the image. The calculated plane coordinate may be stored in a memory.

The panel driver 888 may transmit preset detection image data to the display panel 600 in response to the detection signal. The display panel 600 may further display an information symbol 411 and a scale bar 412 in a portion of the display area 601 of the display panel 600. In one embodiment, the information symbol 411 and the scale bar 412 may be displayed in a translucent state on a left edge portion of the display area 601.

The scale bar 412 may show an approximate magnification or demagnification ratio of an image displayed in the display area 601. The information symbol 411 may be a symbol that, when activated such as by touch, causes the information window to be displayed. The information window may contain useful information and further description thereof is provided below.

FIG. 4A illustrates a scenario in which the user 777 has entered the detection area 500 but has not touched the display area 601. In the case of FIG. 4A, the display area 601 may serve as a transparent window and an outside view (e.g., a building) behind the display panel 600 may be viewed by the user 777 through the transparent display area 601. In this case, the information symbol 411 and the scale bar 412 may be displayed on the right side of the display area 601 in a translucent state.

Next, as illustrated in FIG. 4B, when the display area 601 is touched by the user 777 to magnify an image, the panel driver 888 may recognize the touch and trigger the operation of the back-facing photographing part 702. In other words, the panel driver 888 may enable the back-facing photographing part 702 to photograph a background (e.g., a building) of the display panel 600. The touch gesture for magnifying the image may include, for example, a gesture of gradually increasing the distance between both hands while one or more fingers of each hand touch the display area 601 as illustrated in FIG. 4B. An image of the background photographed by the back-facing photographing part 702 may be converted to data (hereinafter referred to as “background image data”), which may be supplied to the panel driver 888. Thereafter, the panel driver 888 may process the background image data to magnify the background image and supply the magnified background image data to the display panel 600. The display panel 600 may be driven by different drive signals including the magnified background image data so that a magnified background image may be displayed in the display area 601 of the display panel 600. In this case, a magnification ratio of the image that corresponds to the magnified background image may be displayed on the scale bar 412.

Next, as illustrated in FIG. 4C, when the display area 601 is touched by the user 777 to demagnify an image, the panel driver 888 may recognize the touch and trigger the operation of the back-facing photographing part 702. In other words, the panel driver 888 may enable the back-facing photographing part 702 to photograph a background (e.g., a building) of the display panel 600. The touch gesture for demagnifying the image may include, for example, a gesture of gradually decreasing the distance between both hands while one or more fingers of each hand touch the display area 601 as illustrated in FIG. 4C. An image of the background photographed by the back-facing photographing part 702 may be converted to data (hereinafter referred to as “background image data”) and may be supplied to the panel driver 888. Thereafter, the panel driver 888 may process the background image data to demagnify the background image and supply the demagnified background image data to the display panel 600. The display panel 600 may be driven by different drive signals including the demagnified background image data so that a demagnified background image may be displayed in the display area 601 of the display panel 600. In this case, a demagnification ratio of the image may be displayed on the scale bar 412.

Instead of the touch gestures illustrated in FIGS. 4B and 4C, the user 777 may magnify or demagnify the image by directly touching a scale on the scale bar 412 or touching a “+” or “−” symbol associated with the scale bar 412.

According to one embodiment, the display device 100 with a window may have a telescopic function that enables magnification and/or demagnification of a background view that is seen outside the window.

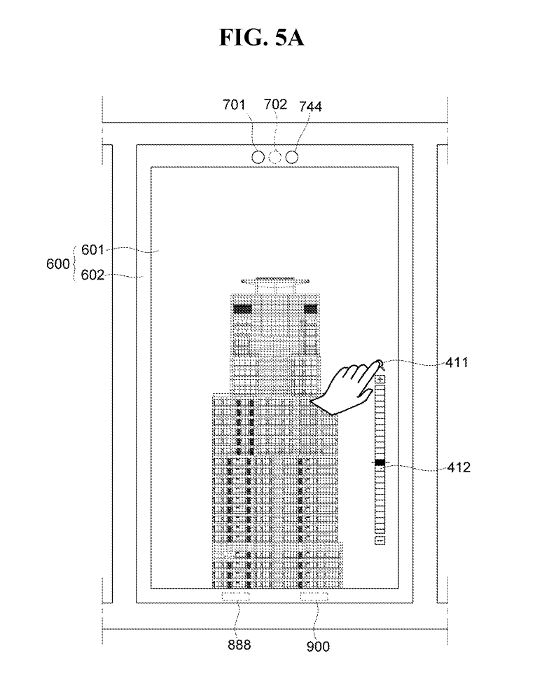

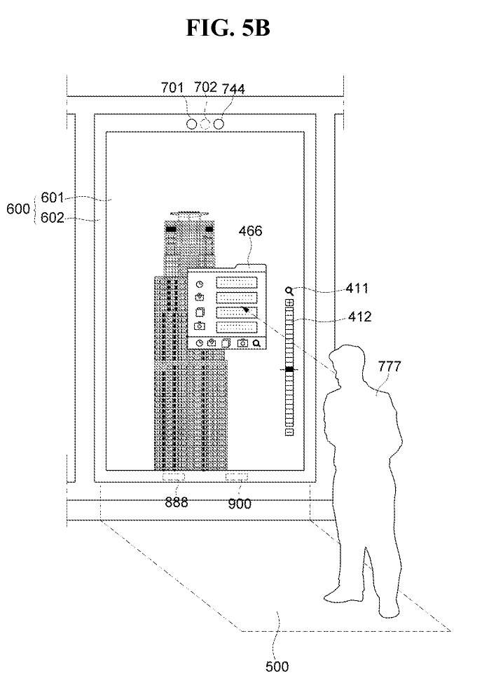

FIGS. 5A and 5B illustrate displaying an information window in a display device 100 with a window according to an embodiment of the present system and method. As illustrated in FIG. 5A, the user 777 may touch the information symbol 411 of the display area 601 to cause an information window 466 (illustrated in FIG. 5B) to be displayed in the display area 601. That is, when the information symbol 411 is touched, the panel driver 888 may recognize the touch, prepare touch image data that correspond to the touch, read a plane coordinate from a memory, correct the prepared touch image data based on the plane coordinate, and supply the corrected touch image data to the display panel 600. The display panel 600 may be driven by different drive signals including the corrected touch image data so that the information window 466 may be displayed in the display area 601 of the display panel 600. In other words, a display location for displaying the information window 466 may be determined by the plane coordinate. For example, the information window 466 may be displayed in the display area 601 to correspond to the eye level of the user 777 for the user's convenience. In some embodiments, a central portion of the information window 466 may be located at the eye level of the user 777 or an upper edge portion of the information window 466 may be located at the eye level of the user 777.

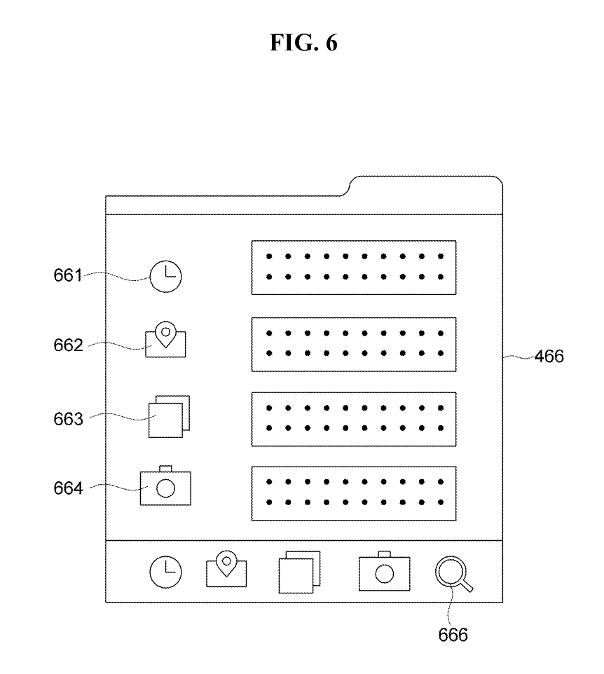

FIG. 6 is a diagram that illustrates a configuration of the information window 466 shown in FIG. 5B. The information window 466 may include symbols 661, 662, 663, and 664, as illustrated in FIG. 6. When the symbol 661 is touched, it may provide previously recorded images of a background, which may be classified by time. In one embodiment, if a specific year in the past and a specific season are selected using the function performed from the symbol 661, a past background image that corresponds to the current background view and to the selected year and season may be displayed in the display area 601. The symbol 661 may also provide a function that allows the user 777 to add a style effect to the past background image. In one embodiment, when the symbol 661 is touched, at least one sub-symbol may be further displayed in the display area 601 so as to offer different style effects. When there are two or more sub-symbols, one of the two or more sub-symbols may be selected by touch, and then the style effect provided by the selected sub-symbol may be added to the past background image.

When the symbol 662 is touched, the display device 100 may display a map of the geographical area being shown in the background. That is, when the symbol 662 is touched, a two-dimensional map of all regions included in the current background that is being shown through the display area 601 may be displayed in the display area 601 as an image. The map may provide information about a geographical location of each region, transportation for traveling to a different region from the current location of the user, and the like.

When the symbol 663 is touched, the display device 100 may provide a search function for facilities or tourist attractions included in the background being shown and their location information. In one embodiment, when the symbol 663 is touched, a text or word input window offering the search function and location information or a specific information window may be displayed in the display area 601 as an image.

When the symbol 664 is touched, it may provide functions for photographing the background and transmitting the captured image of the photographed background to an external or remote device. In one embodiment, when the fourth symbol 664 is touched, the back-facing photographing part 702 may initiate its operation to photograph the background. Then, a typing window may be displayed in the display area 601 so that an external E-mail address, etc. may be input in the typing window and an E-mail may be sent to the external E-mail address along with an image of the photographed background.

As illustrated in FIG. 6, another information symbol 666 may be displayed on the right lower edge portion of the information window 466. When the information symbol 666 is touched, the information window 466 may be closed and may disappear from the display area 601.

All images relating to the functions of the symbols 661 to 664 and the information symbol 666 may be processed by the panel driver 888 and displayed in the display area 601.

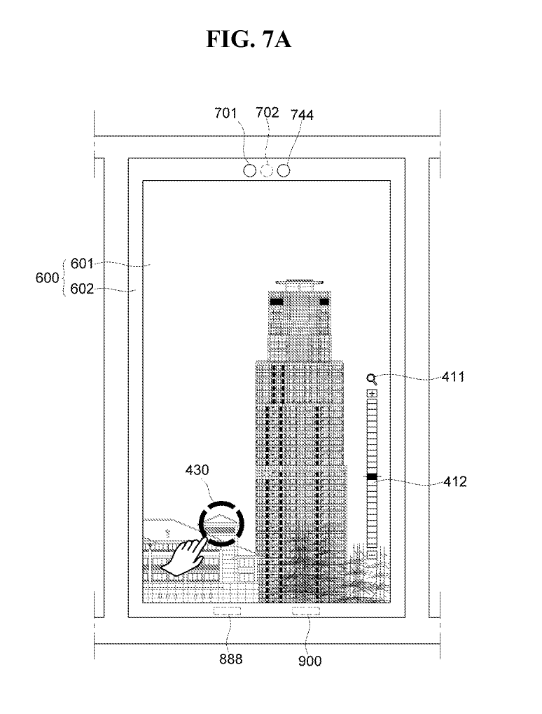

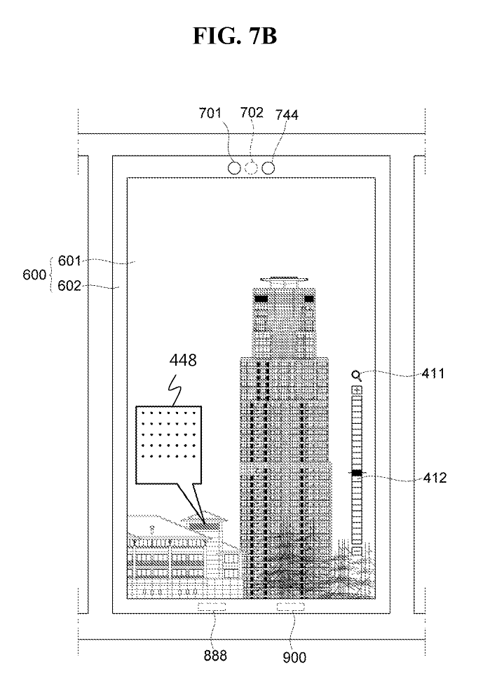

FIGS. 7A and 7B are diagrams that illustrate an operation of a display device 100 with a window according to one embodiment, which results from a touch gesture indicating a specific region. As illustrated in FIG. 7A, the user 777 may touch a specific region of the background shown in the display area 601. In such a case, an image of the background may be displayed in the display area 601 and an indication sign 430 indicating the specific region may also be displayed in the display area 601 as illustrated in FIG. 7A.

In one embodiment, the indication sign 430 may have the shape of a circle and surround the specific region as shown in FIG. 7A. In this case, the circular shape may be formed of a plurality of curves that are not connected to each other such that the circle circumference are disconnected from each other.

Further, although not illustrated, the indication sign 430 may be displayed thickly to emphasize an exterior of a specific region such as a building or a specific floor of the building. After a certain amount of time, the indication sign 430 may disappear from the display area 601 as illustrated in FIG. 7B. Thereafter, a regional information window 448 regarding the specific region may be displayed in the display area 601. That is, if a touch gesture is performed on the display area 601 to indicate the specific region, the panel driver 888 may recognize the touch and allow the back-facing photographing part 702 to photograph a view (e.g., a building) behind the display panel 600. Then, the panel driver 888 may process image data of the photographed background together with touch image data that correspond to the touch and supply the processed image data to the display panel 600. The display panel 600 may be driven by drive signals including the processed image data so that a background image and the indication sign 430 may be displayed in the display area 601 of the display panel 600.

After a certain amount of time, the indication sign 430 may be removed from the display area 601 and the regional information window 448 may be displayed in the display area 601. In one embodiment, the regional information window 448 may be displayed in the display area 601 along with the indication sign 430 at the same time. The regional information window 448 may include a location and/or a detailed explanation of the selected region or building. Further, the regional information window 448 may indicate the selected region or building by including an arrow that indicates the selected region or building.

The regional information window 448 may be displayed to correspond to the eye level of the user, similar to the information window 466. In some embodiments, a central portion of the regional information window 448 may be located at the eye level of the user 777, or an upper edge portion of the regional information window 448 may be located at the eye level of the user 777.

From the foregoing, it will be appreciated that various embodiments in accordance with the present disclosure are described herein for purposes of illustration and are not intended to be limiting. Various modifications may be made without departing from the scope and spirit of the present teachings.

What is claimed is:

1. A display device with a window, comprising:
a display panel configured to detect touch and to display an image;
a back-facing photographing part configured to photograph a background that includes a space behind the display panel; and
a panel driver configured to display a background image photographed by the back-facing photographing part on the display panel and to magnify or demagnify the background image by a touch gesture performed on the display panel so as to display the magnified or demagnified image on the display panel.

2. The display device of claim 1, further comprising:
a user sensor configured to sense whether or not a user is present in a predetermined sensing region;
a front-facing photographing part configured to photograph a foreground that includes a space in front of the display panel; and
a location determining unit configured to calculate a display location for an information window from a foreground image photographed by the front-facing photographing part.

3. The display device of claim 2, wherein when the user sensor detects a user's presence in the predetermined sensing region, the front-facing photographing part photographs the foreground including the user.

4. The display device of claim 2, wherein when the user sensor detects a user's presence in the predetermined sensing region, the panel driver displays an information symbol and a scale bar on the display panel.

5. The display device of claim 4, wherein when the information symbol is touched, the panel driver displays the information window on the display panel in accordance with the display location for the information window.

6. The display device of claim 4, wherein when the user sensor detects a user's absence in the predetermined sensing region, the panel driver removes at least one of the background image displayed on the display panel, the foreground image, the information symbol, the scale bar, and the information window.

7. The display device of claim 4, wherein the panel driver displays the information window on the display panel such that the information window corresponds to an eye level of the user.

8. The display device of claim 2, wherein the information window comprises:
a first symbol configured to provide previous images of the background that are categorized by time period;
a second symbol configured to provide a map showing regions included in the background;
a third symbol configured to provide a search function for facilities or tourist attractions included in the background and also provide location information of the facilities or tourist attractions; and
a fourth symbol configured to activate the back-facing photographing part to capture an image of the background and transmit the captured image of the background to an external device.

9. The display device of claim 8, wherein the first symbol further offers at least one sub-symbol configured to give at least one style effect to the background image.

10. The display device of claim 1, wherein when a specific region included in the background image is touched, the panel driver displays a sign that indicates the specific region on the display panel for a predetermined period of time.

11. The display device of claim 1, wherein the panel driver displays a regional information window that includes regional information associated with the specific region on the display panel and also displays a sign that indicates the specific region on the display panel.

12. The display device of claim 11, wherein the regional information window is displayed on the display panel to correspond to an eye level of a user.
